(19) United States
(12) Patent Application Publication
(10) Pub. No.: US 2016/0116815 A1
(43) Pub. Date: Apr. 28, 2016

(54) METHOD AND APPARATUS FOR DRIVING A REFLECTIVE IMAGE DISPLAY

(71) Applicant: CLEARink Displays LLC, Santa Clara, CA (US)

(72) Inventor: Lorne A. WHITEHEAD, Vancouver (CA)

(21) Appl. No.: 14/971,706

(22) Filed: Dec. 16, 2015

Related U.S. Application Data
(63) Continuation-in-part of application No. 14/874,565, filed on Oct. 5, 2015.
(60) Provisional application No. 62/060,652, filed on Oct. 7, 2014.

(51) Int. Cl. G02F 1/167; G02F 1/133; G02F 1/1343

(52) U.S. Cl. CPC G02F 1/167; G02F 1/134336; G02F 1/13306; G02F 2001/1676

(57) ABSTRACT

The application generally relates to driving reflective image displays utilizing frustration of total internal reflection (TIR) in high brightness, wide viewing angle displays. In one embodiment, a passive matrix driven reflective image display includes a third electrode. The third electrode, which may be perforated, may be positioned within the gap between the front and rear electrodes. The third electrode allows passage of light absorbing electrophoretically mobile particles therethrough. By controlling the voltage biases of the three electrodes, a threshold may be created to impart bistability in the display. Modulating the voltage of the three electrodes also creates pathways for particle movement between the electrodes.

This application is a continuation-in-part, and claims priority to the filing date of application Ser. No. 14/874,565 filed Oct. 5, 2015, which claims priority to Provisional Application Ser. No. 62/060,652 Filed Oct. 7, 2014; the specification of both applications are incorporated herein in their entirety.

### TECHNICAL FIELD

The disclosure generally relates to driving reflective image displays utilizing frustration of total internal reflection (TIR) in high brightness, wide viewing angle displays. More particularly, the application pertains to passive matrix driven reflective image displays containing a third electrode.

### BACKGROUND

A frustratable total internal reflection (FTIR) image display is potentially a much faster switching reflective display technology that enables web browsing and video applications. FTIR display technology utilizes TIR of a front sheet or film comprising of, for example, convex or hemispherical protrusions or micro-prisms to create a bright state. A dark state is created by frustration of TIR when light absorbing particles are moved adjacent the front sheet into the evanescent wave region. The switching speed of an FTIR-based display can be faster than conventional dual particle electrophoretic display technology. This is due to the modulation of particles of only one charge. The particles need to be moved in and out of the evanescent wave region at the hemisphere surface. This distance is much shorter than the movement distance in conventional electrophoretic displays.

FTIR-based displays may be addressed to move the light absorbing charged particles. The movement of the charged particles from one electrode to another creates images. The charged particles may be moved using different methods such as direct drive addressing of a patterned electrode array, active matrix addressing of a thin film transistor (TFT) array and passive matrix addressing of a grid array of electrodes.

In direct drive displays, a display is divided into a plurality of segments in a patterned array. Each display segment has an individual lead to control the segment. Although the patterned array and drive electronics are less expensive to fabricate, direct drive displays are greatly limited. As the number of segments in the display increases, the number of leads also must increase thereby making the display difficult or even impossible to fabricate.

Thin film transistor arrays are commonly used in current liquid crystal display (LCD) technologies and contain a plurality of transistors and capacitors. Each capacitor and transistor is connected to a single pixel, which actively maintains the pixel state while other pixels are being addressed. The advantage of the TFT approach is that the capacitor/transistor combination provides a threshold voltage that enables individual pixels to be addressed using row/column drivers. This is needed if the electro-optical system (e.g., the liquid crystal (LC), the electrophoretic suspension, etc.) does not have an intrinsic voltage threshold. TFT systems are faster and have better voltage control. The fundamental advantage of the TFT array is the ability to control each pixel with the threshold voltage. TFT arrays are excellent drive systems for displays requiring fine structure and detail. However, the TFT arrays are costly to manufacture.

Passive matrix driven displays are composed of an array of electrodes in a grid structure. The grid structure is made of rows and columns with each respective row and column connected to an integrated circuit (IC). The ICs supply charge to the row and column electrodes to address individual pixels at locations where the rows and columns intersect. Passive matrix displays are simple and low cost to manufacture and can provide fine structure and image quality but they have major drawbacks. For example, passive matrix driven displays have slow response times and poor voltage control. In addition, the electro-optical systems of such displays require an intrinsic threshold behavior in the LC or electrophoretic suspension portion of the display. Despite the slow response time, passive matrix displays can be used in a variety of applications that require fine image structure without the need for video rate. Such applications include: electronic shelf labels, billboards and other types of display signage that would be cheaper to fabricate than with TFT drive electronics. Poor voltage control, another drawback, can lead to poor image quality.

FIG. 1 schematically illustrates a portion of a conventional passive matrix grid 100 of electrodes containing a first plurality 102 of rows of individual electrodes 104. Opposing the plurality of row electrodes 102, is a second plurality 106 of columns of individual column electrodes 108 in a perpendicular direction to the first plurality of row electrodes 102. The individual pixels are located where the row and column electrodes intersect. In order to address, for example, the middle pixel (the pixel is highlighted by a dotted line box) of the grid array 100, a first voltage is applied at +10V at the middle column electrode while the other electrodes remain at 0V. A second applied voltage bias of −10V is applied at the middle row electrode while the other row electrodes remain at 0V to form an electromagnetic field therebetween. The voltage difference leads to an overall voltage bias at the desired middle pixel of +20V. An undesired voltage bias of +10V is also applied to the adjacent pixels. Preferably these pixels would not be addressed at +10V but as mentioned in preceding paragraphs, passive matrix displays exhibit poor voltage control. Regardless of the pixel addressed in a specific row or column, all other pixels in the same row or column of said pixel are addressed by an applied voltage, albeit at a lower voltage than the desired addressed pixel.

In the schematic example in FIG. 1, the desired pixel is addressed at +20V and activated while all of the other pixels in the same row and column are addressed at +10V. Unwanted partial activation of the pixels being addressed at +10V may result. A key method to circumvent this problem is to implement a threshold into the display such that the pixels are not activated when a voltage of +10V is applied. Instead, pixels are activated only when a voltage of >10V, such as when +20V is applied. This method, however, has many drawbacks.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a portion of a conventional passive matrix electrode grid;

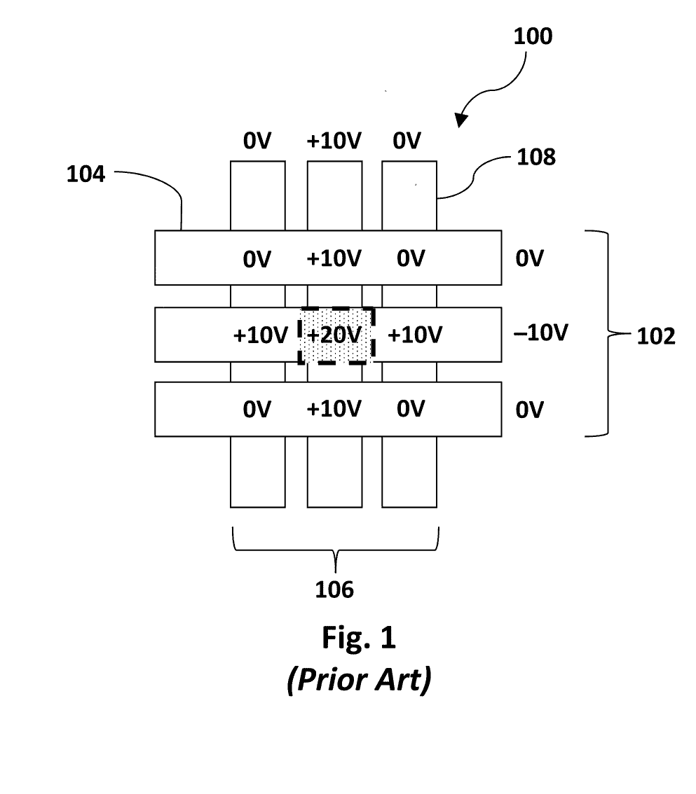

FIG. 2 schematically illustrates a portion of a passive matrix electrode grid further containing a third electrode;

FIG. 3 schematically illustrates design variations of the third electrode;

FIG. 4 illustrates the operation of a single pixel of an exemplary display according to certain embodiments;

FIG. 5 is a graphical representation of operation of the pixel illustrated in FIG. 4 in accordance with one embodiment of the disclosure;

FIG. 6 schematically illustrates operation of a single pixel of a reflective display with a three-electrode passive matrix;

FIG. 7 is a graphical representation of operation of the pixel illustrated in FIG. 6 in accordance with one embodiment of the disclosure;

FIG. 8 illustrates the operation of a single pixel of a reflective display containing the three-electrode passive matrix invention; and

FIG. 9 is a graphical representation of operation of the pixel illustrated in FIG. 8 in accordance with one embodiment of the disclosure.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

In one embodiment, the disclosed principles provide a method and apparatus to provide a threshold in passive matrix driven FTIR-based displays and other reflective display architectures. In an exemplary embodiment, a third electrode is interposed between the first electrode and the second electrode. The third electrode provides a threshold control for the movement of electrophoretic particles between the first and the second electrodes.

In one embodiment of the disclosure, a passive matrix display includes a group of first electrodes and a group of second electrodes. The first group and the second group of electrodes are positioned perpendicular with respect to each other. The electrodes are connected to ICs capable of applying a charge to each individual electrode. For reflective image displays, the electrophoretically mobile particles suspended in a medium are positioned in the cavity between the opposing first and second electrodes.

In certain embodiments, a third electrode (interchangeably, a trapping electrode) is interposed between the first group and second group of opposing electrodes. The third electrode may be a continuous wire mesh or a perforated sheet. The third electrode may comprise conductive material. By controlling the charge applied to the three electrodes, a method is described to provide a threshold voltage to prevent particles from moving during operation while addressing other pixels in the same row or column. The disclosed embodiments further impart bistability into the display architecture described herein. Bistability occurs when the display retains its image when the power is off or is at a non-driving voltage.

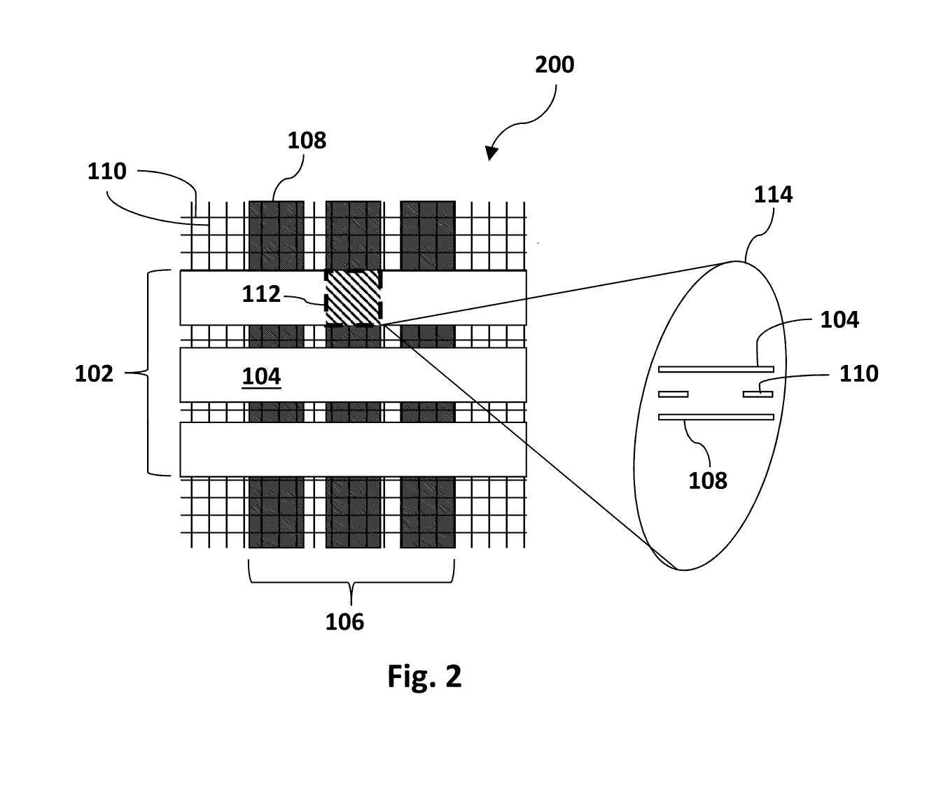

FIG. 2 is a schematic illustration of one embodiment of the disclosure. Specifically, FIG. 2 illustrates a portion of a passive matrix electrode grid having a third electrode. The passive matrix grid 200 with a third electrode contains a first plurality of front (interchangeably, frontward) row electrodes 102. The frontward electrodes 102 are made up of individual electrodes 104. The frontward row electrodes 104 may be substantially transparent and may comprise indium tin oxide (ITO), an electrically conducting polymer such as BAYTRON® or nanoparticles dispersed in a transparent polymer such as carbon nanotubes or metallic nanowires made from silver or other metals.

Grid 200 also includes a second plurality of rear (interchangeably, rearward) column electrodes 106. Rear electrodes 106 include individual column electrodes 108. Column electrodes 108 have been darkened for clarity. Column electrodes 108 may comprise of similar material as that of front electrodes 102. It is not necessary that the column electrodes be transparent. Column electrodes 108 may also be made of carbon or conductive metals such as aluminum, copper, silver or gold or other electrically conductive material or a combination thereof. A cavity is formed between the plurality of front 102 and plurality of rear 106 electrodes.

FIG. 2 also shows third electrode 202 interposed between frontward plurality of row electrodes 102 and rearward plurality of column electrodes 106. The third electrode (interchangeably, trapping or middle electrode) 202 may define a continuous conductive material. In the embodiment of FIG. 2, third electrode 202 is illustrated as a continuous wire mesh. A wire mesh-like design is presented for descriptive purposes and should not limit the disclosed principles.

An individual pixel 204 located at the intersection of the top row electrode and middle column electrode and is exploded as 206 for illustrative purposes. Pixel 204 includes front 104 electrode, rear electrode 108 and third electrode 202. In addition, pixel 204 is highlighted by a box with dotted lines and filled by cross-hatched lines. Exploded view 206 illustrates a cross sectional view of a front row electrode 104, a cross-sectional view of a rear column electrode 108 and a cross-sectional view of the third continuous middle electrode 202 which is interposed between the front and the rear electrodes. In one embodiment, at least one aperture of the third electrode 202 interposes a span between one of the plurality of the frontward row electrodes and one of the plurality of the rearward column electrodes.

A voltage source (not shown) may additionally supply substantially uniform voltages to the each of the three electrodes. The voltage source may independently bias each of the three electrodes. Alternatively, the voltage source may bias one or more of the three electrodes as a function of the bias applied to the other electrode(s). A controller comprising a processor circuitry, a memory circuitry and switching circuitry may be used to drive each of the three electrodes. The memory circuitry may store instructions to drive the processor circuitry and the switching circuitry thereby engaging and disengaging electrodes according to predefined criteria.

The passive matrix grid 200 may also include a fluidic medium 208. The medium may be disposed in a housing (not shown) that contains all three electrodes. The medium fills the spaces between and around front electrodes 104 and rear electrodes 108. The medium may be air, a clear liquid or any other suitable fluidic medium. In other embodiments, the medium may be colored. The medium may be a fluorinated inert, low refractive index, low viscosity liquid such as a fluorinated hydrocarbon. An inert, low refractive index (i.e., less than about 1.35), low viscosity, electrically insulating liquid such as, Fluorinert™ perfluorinated hydrocarbon liquid (η₃˜1.27) available from 3M, St. Paul, Minn., may be a suitable fluid for the medium. Other liquids such as Novec™ also available from 3M may also be used as the fluid for the medium.

The passive matrix grid 200 may further include at least one or a plurality of electrophoretically mobile light absorbing particles 210. The particles may be suspended in the fluidic medium 208 disposed between the plurality of front 102 and rear 106 electrodes. The particles may have a positive or negative charge. The particles may comprise inorganic material such as a metal oxide-based pigment. The particles may comprise a carbon-based material such as carbon black or other carbon-based pigment. The particles may comprise a combination of inorganic and carbon based material. In one embodiment, the particles may comprise a metal oxide-based core material with an outer layer or coating of adhered polymer. In another embodiment, the particles may comprise a carbon-based core such as carbon black or graphite with an outer layer or coating of adhered polymer.

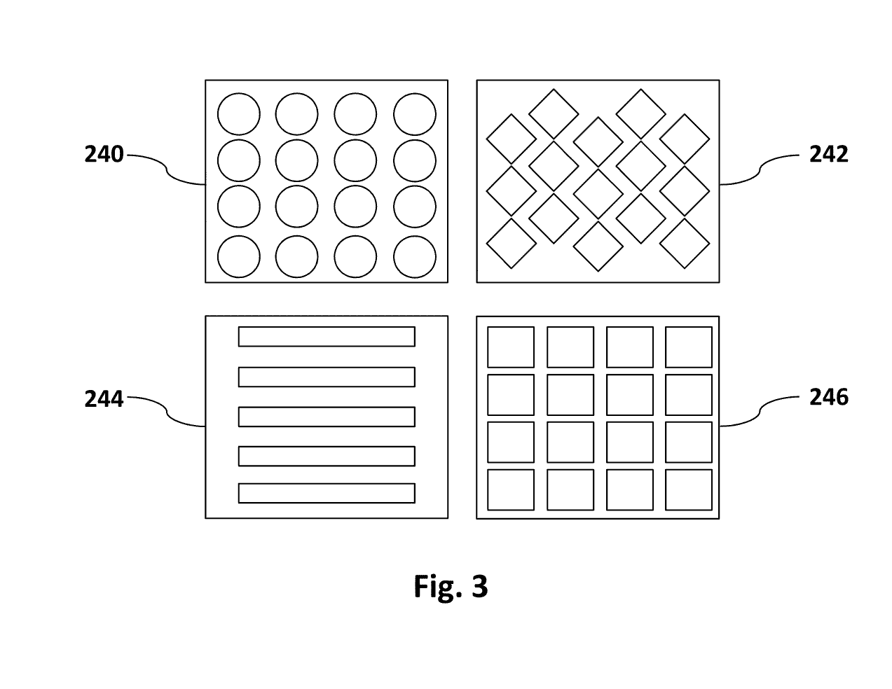

FIG. 3 schematically illustrates design variations of the third electrode. Specifically, FIG. 3 shows top view of various exemplary designs for the trapping electrode. In FIG. 2 the third electrode 202 was depicted as a continuous wire mesh for illustrative purposes only. The third electrode may also be, for example, in the form of a continuous perforated sheet 240 with circular perforations 242, a continuous perforated sheet 244 with diamond perforations 246, a continuous perforated sheet 248 with rectangular perforations 250 or a continuous perforated sheet 252 with square perforations 254, or combinations thereof. The perforations, troughs or apertures allow particles passage through the third electrode. The perforations may further be random in size and distribution. Perforation density of the third electrode (e.g., electrode 202, FIG. 2) may also vary and may have high perforation density such as in a wire mesh of at least about 60%. In other words, the perforations may constitute at least about 60% of the total surface area of the third electrode. The third electrode 202 may have low perforation density of at least about 10%. Perforation density may range from about 10% to about 90% or more. In one embodiment, the diameter of the perforations are substantially greater than the diameter of an average electrophoretic particle. For example, the aperture diameter may be at least about 10 times the average diameter of the electrophoretically mobile particles. The third electrode may be comprise metal or plastic film with a coating of a metal or other electrically conducting material.

In order to control the gap between any two adjacent electrodes, spacer structures may be used. The spacer structures may also be used to support the various layers in the display. The spacer structures may be in the shape of circular or oval beads, blocks, cylinders or other geometrical shapes or combinations thereof. The spacer structures may comprise glass, plastic or other resin.

In other embodiments, any of the three-electrode reflective image displays described herein may further include at least one edge seal. An edge seal may be a thermally or photochemically cured material. The edge seal may contain an epoxy, silicone or other polymer based material.

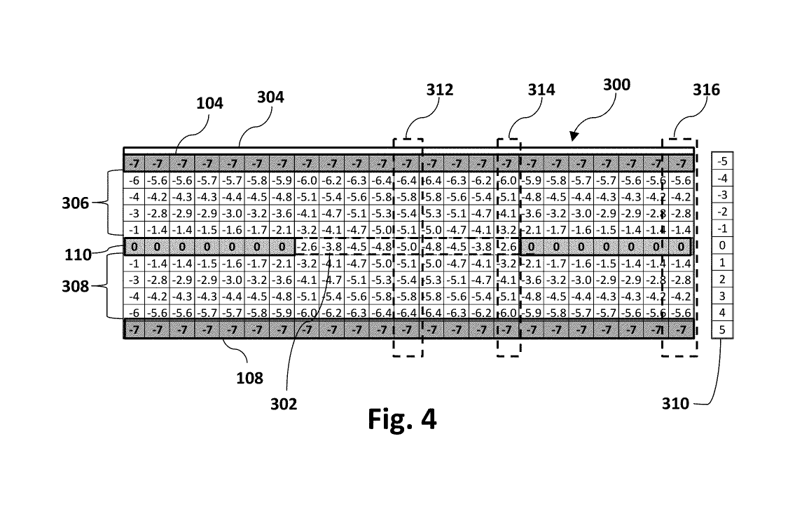

FIG. 4 illustrates the operation of a single pixel of an exemplary display according to certain embodiments. This is substantially the same area of a single pixel illustrated in exploded view 206 in FIG. 2. A reflective image display contains a plurality of interconnected single pixels. For simplicity, only a single pixel is proffered. The single pixel 400 shown in FIG. 4 contains a first front electrode layer 104 and a second rear electrode layer 108. A continuous and perforated porous third electrode layer 202 acting as the trapping electrode is interposed between the front 104 and rear electrode 108 layers. The front electrode 104 and rear electrode 108 layers are grayed and the third electrode layer 202 is crosshatched in FIG. 4 to better illustrate each electrode. The dashed lines 402 represent the continuous nature of the third electrode layer 202 and represent where a perforation or aperture may reside.

Pixel 400 may further include one or more a transparent outer layer or sheet 404 through which a viewer views the display. Additional structural support (not shown) may be provided to keep various electrodes and other structures in place. The transparent layer may be a sheet further capable of total internal reflection including a plurality of, for example, micro-prisms, hemispherical or convex protrusions. The outer sheet 404 may comprise glass or a polymer, such as polycarbonate or polyethylene terephthalate (PET).

Pixel 400 may further include a clear medium with suspended and charged electrophoretically mobile light absorbing particles (not shown) residing or disposed in a gap between the front 104 and rear 108 electrodes. The medium and particles have been omitted for clarity in the illustration of the display pixel 400. The medium may be air or a clear or transparent liquid or fluidic medium. In some embodiments the medium may be colored. The medium may be a fluorinated inert, low refractive index, low viscosity liquid such as a fluorinated hydrocarbon.

The single pixel 400 of a passive matrix display containing a third electrode may be operated as follows. In the following description, it is assumed that the charged particles would be positively charged though they also may be negatively charged. As shown in the single pixel in FIG. 4, the top 104 and rear 108 electrodes both have an applied voltage of −7V to form an electromagnetic field between the electrodes. Thus, both electrode layers have substantially the same applied bias. In the absence of a third electrode layer, positively charged particles (not shown) would be attracted to either the front or the rear electrode layers where the magnitude of the bias is the greatest. The particles migrate to either electrode layer thus making it more difficult to control the movement of the particles. A voltage of 0V may be applied to the third electrode layer 202 to disrupt the electromagnetic field between the front and rear electrodes. Voltage gradients may be altered or disrupted within regions 406 and 408 to provide a voltage barrier or threshold to particle movement. The voltage at the third trapping electrode can be changed to modulate movement of particles between the front and rear electrodes. The voltage values shown between the front 104 and rear electrode 108 layers are illustrative voltages which may be approximate averages of the nearest neighbor voltages. These values are listed in rows for illustration purposes. Each row having a point of reference 410 that is assigned a reference row of −5 to 5. Reference row −5 is the top electrode 104 with an applied −7V bias. Reference row 5 is the rear electrode 108 with an applied voltage of bias of −7V. The third electrode 202 with an applied voltage of 0V is at reference row 0.

There may exist a continuum of voltages or voltage gradients between the electrodes in the single pixel with a resulting infinite number of rows. The voltage gradients may be controlled by the applied voltages to each of the three electrode layers 104, 108, 202. The voltage gradient may also be controlled by the gap distances between the three electrode layers. For simplicity, the number of rows is limited to 11 (i.e., −5, −4, −3, −2, −1, 0, 1, 2, 3, 4 and 5). It should be noted that the applied voltage biases shown in the single pixel in FIG. 4 are arbitrary and may be changed based on the requirements of the display application.

Examining the resulting voltages between the electrode layers it may be seen that particles of positive charge polarity would prefer to reside at either the front or the rear electrode where they are attracted to the electrode layers 104, 108 (where the most negative bias exists). In order for the particles to move from one electrode to the other, the particles must pass through regions of less negative (i.e., more positive) bias as seen in FIG. 4. As the positively charged particles are more attracted to the negative biases at the front 104 and rear electrode 108 surfaces, the less negative voltage regions provide a barrier to the particles to move from one electrode to the other. This may also be illustrated by graphically examining the voltages in three regions within the pixel: at the center of the pixel and in the middle of a perforation of the third electrode 412, at an edge of a perforation of the third electrode 414 and at one end of the pixel 416. Boxes with dashed lines highlight the regions 412, 414 and 416.

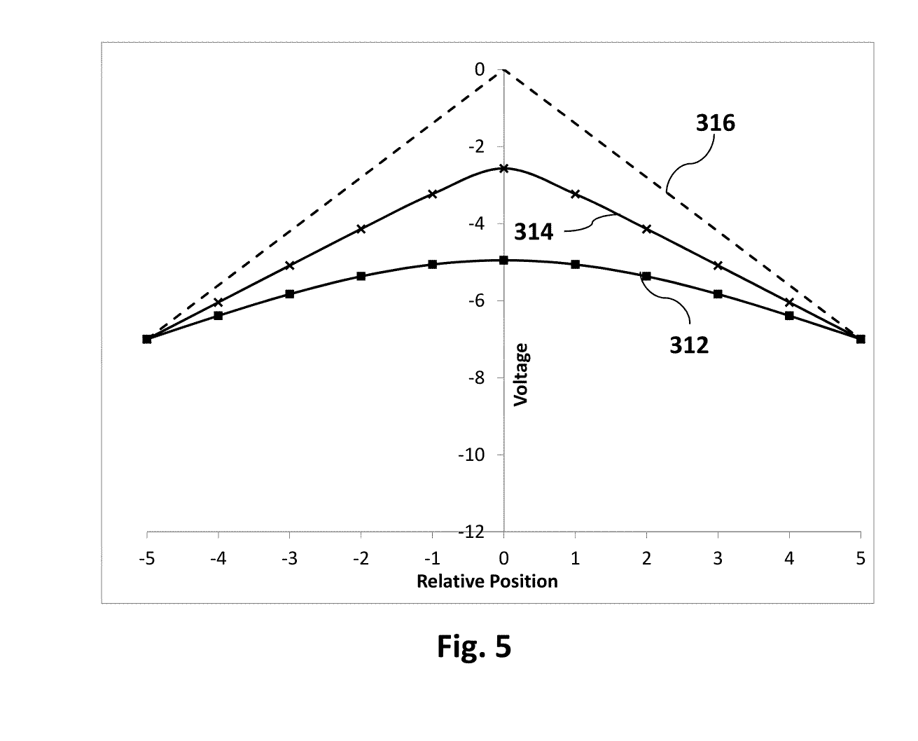

FIG. 5 is a graphical representation of voltage regions in the pixel illustrated in FIG. 4. The x-axis in FIG. 5 is the relative position 410 or reference row of voltages. The y-axis is the voltage at the specific reference point. The voltage in each highlighted region in FIGS. 4 (412, 414 and 416) is graphically represented in FIG. 5 by labeled plot curves. If a positively charged particle resides at either one of the electrode surfaces at position 5 or −5, the applied voltage is −7V (as illustrated in FIG. 4). In order for a particle located in any of the regions 412, 414 or 416 to pass from one electrode to the other, the particles must pass through less preferred areas of less negative (i.e., more positive) bias. As illustrated in FIG. 5, at position 0 the voltage bias is less negative at −5V where the positively charged particles must pass when moving from one electrode to the other. This will not happen as the positively charged particles are attracted to the most negative voltage bias, −7V, at the front 104 and rear 108 electrodes. Thus, the pixel as depicted in FIG. 4 and graphically represented in FIG. 5 is at a non-moving potential. In other words, the particles are locked or trapped in their positions (relative to the third electrode) by the arrangement of the applied voltages to one or more of the electrodes 104, 108, 202. In one exemplary embodiment, the third electrode 202 provides a threshold voltage (barrier to movement) to prevent movement of the positively charged particles despite a negative voltage applied at both the front 104 and rear 108 electrodes. The disclosed barrier to movement also imparts bistability within the pixel. A key requirement of passive matrix driven reflective displays is that as bias is applied on the row and column electrodes to address and activate a single pixel, the other addressed pixels in the same row and column electrodes should remain inactive. This is despite being addressed by the applied voltage in the row and column electrodes.

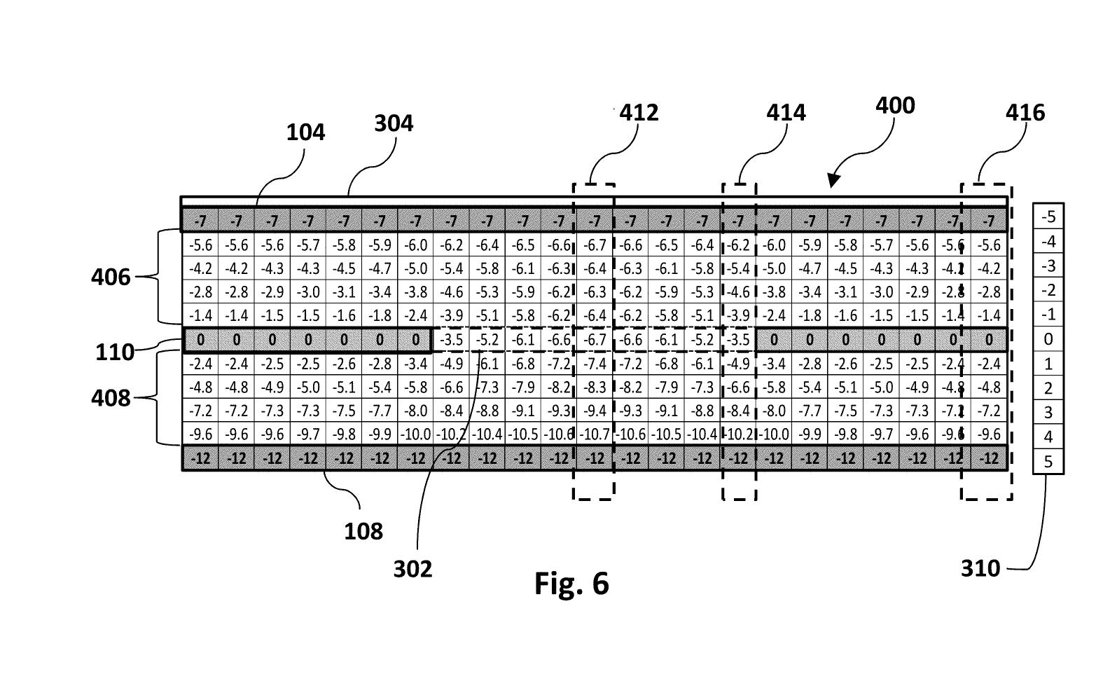

FIG. 6 schematically illustrates operation of a single pixel of a reflective display with a three-electrode passive matrix. Pixel 600 of FIG. 6 may be of similar design and construction as pixel 400 of FIG. 4. The applied bias at the three electrodes, 104, 108 and 202 of FIG. 6 is different than that of FIG. 4.

In the single pixel of FIG. 6, the top electrode layer has an applied voltage bias of −7V and the rear electrode layer has an applied voltage of about −12V to create an electromagnetic field between the two electrodes. In the absence of a third electrode, positively charged particles will attracted to the rear electrode layer 108 where most negative bias exists. By integrating a third electrode layer 202 and applying a voltage of 0V, modified voltage gradients may be created within regions 606 and 608. This provides a voltage barrier to particle movement despite the 5V difference between the front 104 and rear 108 electrodes. The numbers lying between the front 104 and rear electrode 108 layers are voltages which are approximate averages of the nearest neighbor voltages as previously described. The voltages are listed in rows; each row for a point of reference 610 is assigned a reference row of −5 to 5. Reference row −5 is the top electrode with an applied −7V bias. Reference row 5 is the rear electrode with an applied voltage bias of −12V. The third electrode with an applied voltage of 0V is at reference row 0.

Examining the resulting voltages between the electrode layers it can be seen that the particles of opposite charge polarity reside at either the front 104 or the rear electrode 108. This is despite the 5V difference. In order for the particles to move from one electrode to the other, particles must pass through a region of less negative (i.e., more positive) bias. As the positively charged particles are attracted to the more negative voltages at the front and rear electrode surfaces, the less negative voltage regions provide a barrier to move from one electrode to the other. This may be further illustrated by graphically examining the voltages in three regions within the pixel: at the center of the pixel and in the middle of a perforation in the third electrode 612, at an edge of a perforation of the third electrode 614 and at one end of the pixel 616. Boxes with dashed lines highlight the regions 612, 614 and 616.

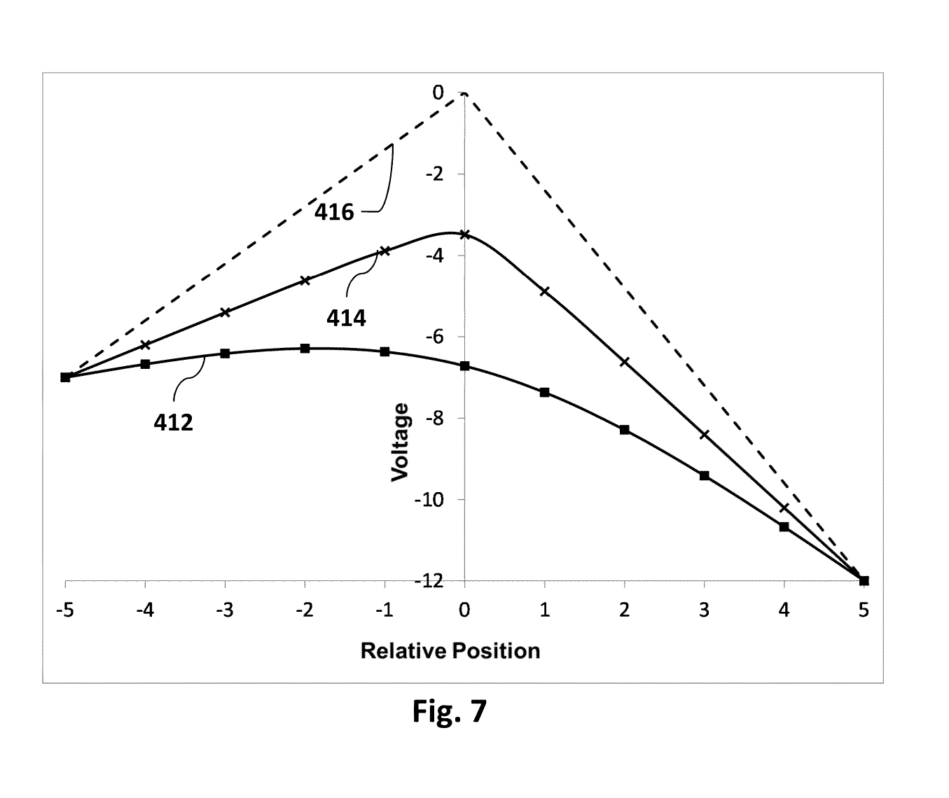

FIG. 7 is a graphical representation of operation of the pixel illustrated in FIG. 6. The x-axis in the plot in FIG. 7 is the relative position 610 or reference row of voltages and the y-axis is the voltage at the specific reference point. The voltage in each highlighted region in FIGS. 6, 612, 614 and 616, is graphically represented in FIG. 7 by labeled plot curves. If a positively charged particle resides at the front electrode surface at position −5, the applied bias is −7V as illustrated. If a positively charged particle resides at the rear electrode surface at position 5, the applied voltage bias is −12V as illustrated in FIG. 6. In order for a particle located in any of the regions to pass from one electrode to the other, the particles must pass through areas of less negative (i.e., more positive) voltages. This will not occur as the positively charged particles will be attracted to the more negatively charged electrodes. The pixel as depicted in FIG. 6, and graphically represented in FIG. 7, is at a non-moving potential despite the large potential difference between the front 104 and rear 108 electrodes. In other words, the particles are locked or trapped in their positions by the arrangement of the applied voltages by the three electrodes. The third electrode provides a threshold voltage to prevent movement of the positively charged particles despite the different voltages applied at the front and rear electrodes.

It should be further noted that in order for a positively charged particle located at the front electrode 104 in FIG. 6, to move to the rear electrode 108, it must pass through a region of more positive voltage of about −6.3V (at position −2 in region 412). This is a difference of only about 0.7V. Comparatively in the arrangement in FIG. 4, a positively charged particle located at the front electrode 104 is also attracted to a −7V bias but it must pass through a region of more positive voltage of about −5V (at position 0 in region 412) which is a difference of about 2V. In both instances in FIGS. 4 and 6, a barrier to movement of the positively charged electrophoretic particles is provided in both instances even though the magnitude of the barrier (i.e., voltage) is different (0.7V vs 2V). The barrier may be modified by careful control of the biases applied at the front, rear and third electrodes.

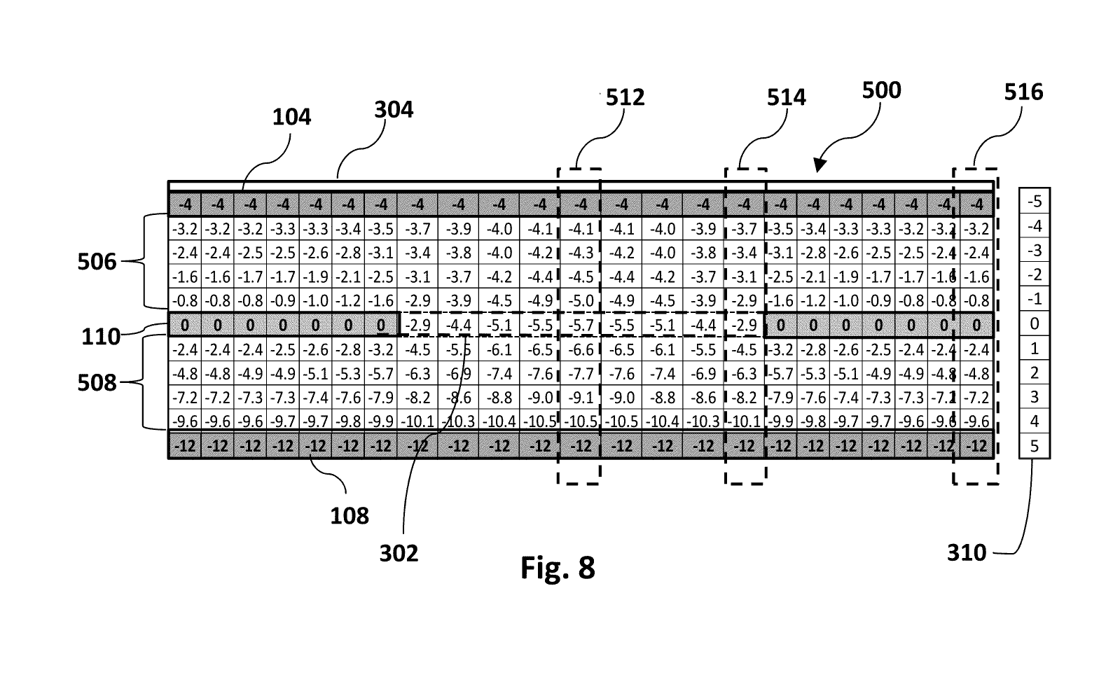

FIG. 8 illustrates the operation of a single pixel of a reflective display containing the three-electrode passive matrix invention. The single pixel 800 depicted in FIG. 8 is of the same design and construction as the pixel in FIGS. 2, 4 and 6 except that the applied voltage bias at the three electrodes, 104, 108 and 202 are different.

In the example of FIG. 8, a larger difference in voltage is applied at each of the three electrodes as compared with those shown in FIG. 6. In the single pixel in FIG. 8, the top electrode layer has an applied voltage bias of −4V (instead of −7V as shown in FIG. 6) and the rear electrode layer has an applied voltage bias of −12V. In the absence of a third electrode layer, the positively charged particles within the pixel would be preferentially attracted to the rear electrode layer 108 where the most negative bias of −12V exists. By integrating a third electrode layer 202 the particle movement may be disrupted and modulated.

In contrast to FIGS. 4 and 6, display 800 in FIG. 8 provides a pathway in the voltage arrangement of the three electrodes for particles to pass from the front electrode to the rear electrode in region 812 through cavities 806 and 808. This may be accomplished by increasing the voltage on the front electrode 104 from −7V to −4V. This is better illustrated by graphically examining the voltages in three regions within the pixel 812, 814 and 816. Boxes with dotted lines highlight the regions 812, 814 and 816.

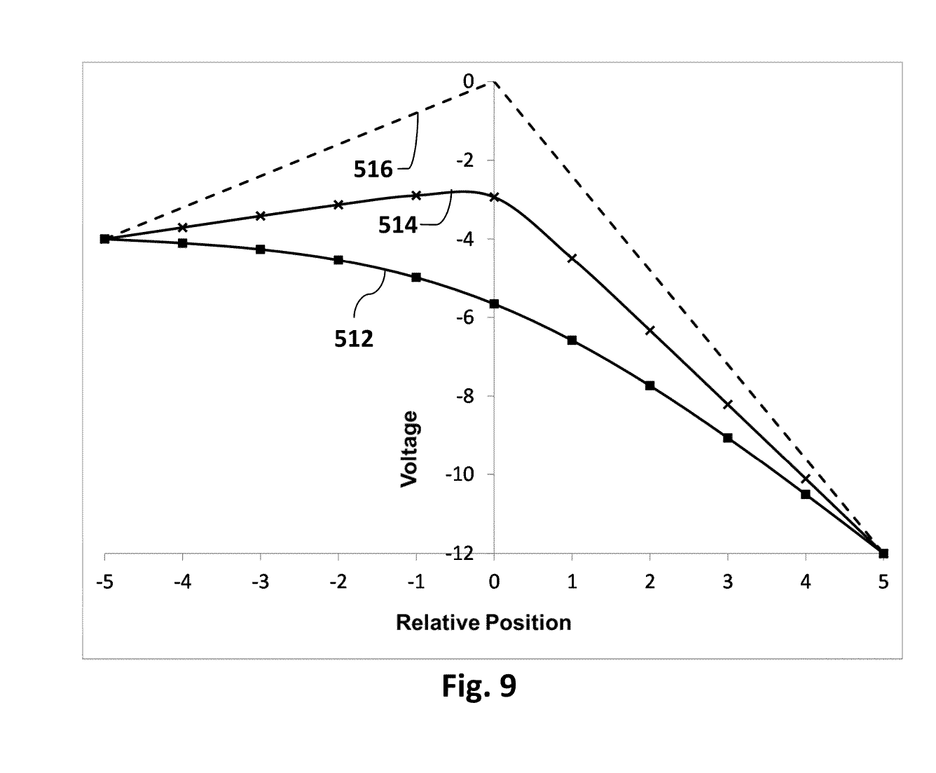

FIG. 9 is a graphical representation of operation of a pixel illustrated in FIG. 8. The x-axis in the plot in FIG. 9 is the relative position 810 or reference row of voltages and the y-axis is the voltage at the specific reference point. The voltages in each highlighted region in FIGS. 8 (812, 814 and 816) are graphically represented in FIG. 9 by labeled plot curves. If a positively charged particle resides at the front electrode surface at position −5, the applied voltage bias is −4V as illustrated in FIG. 8. If a positively charged particle resides at the rear electrode surface at position 5, the applied voltage is −12V as illustrated in FIG. 8. By plotting the voltages of the three regions 812, 814 and 816 in FIG. 9 it shows region 812 provides a pathway for particles to move from the front electrode to the rear electrode. Region 812 is located approximately in the middle of a perforation. Particles in this region would be exposed to an increasingly more negative and thus a more attractive bias as the particle travels from the front electrode 104 (at position −5) to the rear electrode 108 (at position 5). Other particles suspended in the medium and near this region may migrate to this region such as, for example, by the so-called Brownian motion. The particles may then subsequently electrophoretically move to the rear electrode.

The pixel as depicted in FIG. 8 is at a voltage potential that enables the particles to pass through the apertures in the third electrode as opposed to a voltage potential that prevents the particles from passing through the apertures or perforations as discussed in relation to FIGS. 4-7. In other words, the particles are not locked or trapped in their positions by the arrangement of the applied voltages by the three electrodes. The example in FIG. 8 (graphically represented in FIG. 9) shows how the voltages may be controlled to provide a pathway for the particles to be electrophoretically moved between the electrodes. Additionally at a given potential, gray states may be achieved by the length of time that a pixel is held in a state where particles may be allowed to move from one electrode to the other.

In another embodiment the third electrode 202 may provide a reflective surface to reflect light back to the viewer to enhance the brightness of the display. Front sheets 404 comprising of a plurality of, such as for example, micro-prisms, hemi-spherical or convex protrusions exhibit a problem commonly referred to as the so-called dark pupil problem. The “dark pupil” problem typically reduces the reflectance of the display. Light rays may pass through the non-reflective center region (i.e., the dark pupil region) and may be lost. The dark pupil problem may be addressed by reflecting light rays off of the third electrode 202, back towards and through the pupil region and towards the viewer. In one embodiment of the disclosure, the light arrays are thus recycled. In an exemplary embodiment, the dark pupil problem is resolved and display brightness is enhanced by adding a reflective third electrode to reflect the light back through the pupil and towards the viewer.

The three-electrode invention described herein is a general method to provide a threshold in passive matrix driven reflective displays. This is done by careful control of the applied voltages to the row, column and third electrodes. In some embodiments it may be applied to reflective displays with clear front sheets. In other embodiments it may be applied to reflective displays with front sheets capable of total internal reflection. Though specific bias arrangements amongst the three electrodes have been disclosed it should be noted that these voltage arrangements (i.e. −7V/0V/−7V, −7V/0V/−12V and −4V/0V/−12V) were arbitrary and for illustrative purposes only. An infinite number of bias arrangements amongst the three electrodes may be employed. Specific voltage arrangements will be dependent on a number of factors such as, but not limited to, the magnitude of the charge on the particles, mobility of said particles in the suspending medium, polarity of said particles, gap distance of the three electrodes, perforation size and density of the third electrode 202 and desired switching speed of the display. Furthermore, the examples disclosed herein used positively charged particles and applied negative voltages. Alternatively, negatively charged particles may also be used with applied positive voltages. A combination of positive and negative applied voltages may be used amongst the three electrodes.

In some embodiments dielectric layers may be employed in the pixel designs disclosed herein. Dielectric layers provide protective layers for the electrodes. The dielectric layers may be composed of an inorganic material or organic material or a combination thereof. In some embodiments the dielectric layers may be composed of a polymer such as parylene. In other embodiments the dielectric layers may be composed of halogenated parylenes such as parylene C, parylene D, parylene F or parylene AF-4. In other embodiments the dielectric layer may be SiO₂ or a combination of SiO₂ with parylene or with a halogenated parylene.

In some embodiments a directional front light or a color filter array layer may be employed with the display design described herein. In other embodiments both a front light and a color filter may be employed with the display design described herein. In other embodiments a light diffusive layer may be used with the display to “soften” the reflected light observed by the viewer. In other embodiments a light diffusive layer may be used in combination with a front light or a color filter layer or a combination thereof.

In some embodiments, a tangible machine-readable non-transitory storage medium that contains instructions may be used in combination with the three-electrode display described herein. In other embodiments the tangible machine-readable non-transitory storage medium may be further used in combination with one or more processors.

The following non-limiting embodiments further illustrate embodiments of the disclosure. Example 1 relates to a reflective image display, comprising: a transparent front sheet; a plurality of frontward row electrodes; a plurality of rearward column electrodes, the plurality of rearward column electrodes positioned apart from the plurality of frontward row electrodes; a trapping electrode interposed between the plurality of frontward row electrodes and the plurality of rearward column electrodes, the trapping electrode comprising a plurality of apertures such that at least one aperture intersects a span between one of the plurality of the frontward row electrodes and one of the plurality of the rearward column electrodes; and a voltage source to bias at least one of the plurality of frontward row electrodes, the rearward column electrodes and the trapping electrode.

Example 2 relates to the image display of example 1, wherein the plurality of frontward row electrodes and the plurality of rearward column electrodes are positioned to form a cavity therebetween.

Example 3 relates to the image display of example 1, wherein the trapping electrode comprises a continuous mesh.

Example 4 relates to the image display of example 1, further comprising at least one electrophoretic particle.

Example 5 relates to the image display of example 4, wherein the voltage bias source is configured to bias the trapping electrode relative to the frontward row electrodes and the rearward column electrodes to affect movement of the at least one electrophoretic particle.

Example 6 relates to the image display of example 1, wherein a first of the frontward row electrodes and a first of the rearward column electrodes are positioned relative to a first of the plurality of apertures to form a pixel controllable by the voltage bias source.

Example 7 relates to the image display of example 4, further comprising a dielectric layer.

Example 8 relates to the image display of example 7, wherein the dielectric layer comprises a polymer or an inorganic material.

Example 9 relates to the image display of example 4, further comprising a color filter array layer.

Example 10 relates to the image display of example 4, further comprising a front light.

Example 11 relates to the image display of example 4, further comprising a light diffusive layer.

Example 12 relates to an addressable pixel in a multi-pixel device, comprising: a first electrode positioned substantially across from a rear electrode, the first electrode and the second electrode forming an electrode pair; a voltage bias source coupled to the first electrode and the second electrode, the voltage bias source forming an electromagnetic field between the first electrode and the second electrode; at least one charged electrophoretic particle and a medium disposed in between the first electrode and the second electrode; and a trapping electrode positioned in the medium and interposed between the first electrode and the second electrode, the trapping electrode biased with a first voltage to modulate movement of the at least one electrophoretic particle from the first electrode to the second electrode.

Example 13 relates to the addressable pixel of example 12, wherein the medium defines a fluidic medium.

Example 14 relates to the addressable pixel of example 12, wherein the trapping electrode further comprises a continuous conductive mesh.

Example 15 relates to the addressable pixel of example 12, wherein the trapping electrode further comprises at least one aperture to allow passage of the at least one electrophoretic particle therethrough.

Example 16 relates to the addressable pixel of example 12, wherein the voltage bias source is configured to supply a substantially uniform voltage bias to the first and the second electrode.

Example 17 relates to the addressable pixel of example 12, wherein the voltage bias source is configured to supply a modulating voltage bias to the trapping electrode.

Example 18 relates to the addressable pixel of example 17, wherein the modulating voltage is configured to impede movement of the at least one electrophoretic particle from the first electrode to the second electrode.

Example 19 relates to a method for addressing a pixel in a multi-pixel display, the method comprising: positioning at least one charged electrophoretic particle in a transparent medium disposed between a pair of opposing electrodes of an electrode pair; biasing each electrode of the electrode pair with an initial voltage bias to form an electromagnetic field therebetween to attract the charged electrophoretic particle to one of a first electrode or the second electrode of the electrode pair; and providing a threshold voltage bias at a location between the pair of opposing electrodes, the threshold voltage disrupting the electromagnetic field to thereby prevent movement of the at least one charged electrophoretic particle from the first electrode of the electrode pair to the second electrode of the electrode pair.

Example 20 relates to the method of example 19, wherein the step of biasing each electrode further comprises biasing each of the first electrode and the second electrode to substantially the same voltage bias.

Example 21 relates to the method of example 19, wherein the step of biasing each electrode further comprises biasing each of the first electrode and the second electrode to different voltage biases.

Example 22 relates to the method of example 19, wherein the step of biasing each electrode further comprises forming a voltage gradient between the first electrode and the second electrode.

Example 23 relates to the method of example 19, further comprising modulating the threshold voltage bias to control movement of the at least one electrophoretic particle between the first and second electrode.

Example 24 relates to the method of example 23, further comprising addressing the pixel by modulating the threshold voltage bias to move the at least one electrophoretic particle from the first electrode to the second electrode.

Example 25 relates to a tangible machine-readable non-transitory storage medium that contains instructions, which when executed by one or more processors results in performing operations comprising: positioning at least one charged electrophoretic particle in a transparent medium disposed between a pair of opposing electrodes of an electrode pair; biasing each electrode of the electrode pair with an initial voltage bias to form an electromagnetic field therebetween to attract the at least one charged electrophoretic particle to one of a first electrode or the second electrode of the electrode pair; and providing a threshold voltage bias at a location between the pair of opposing electrodes, the threshold voltage interrupting the electromagnetic field to thereby prevent movement of the at least one charged electrophoretic particle from the first electrode of the electrode pair to the second electrode of the electrode pair.

Example 26 relates to the tangible machine-readable non-transitory storage medium of example 25, wherein the step of biasing each electrode further comprises biasing each of the first electrode and the second electrode to substantially the same bias.

Example 27 relates to the tangible machine-readable non-transitory storage medium of example 25, wherein the step of biasing each electrode further comprises biasing each of the first electrode and the second electrode to different biases.

Example 28 relates to the tangible machine-readable non-transitory storage medium of example 25, wherein the step of biasing each electrode further comprises forming a voltage gradient between the first electrode and the second electrode.

Example 29 relates to the tangible machine-readable non-transitory storage medium of example 25, further comprising modulating the threshold voltage bias to control movement of the at least one electrophoretic particle between the first and second electrode.

Example 30 relates to the tangible machine-readable non-transitory storage medium of example 29, further comprising addressing the pixel by modulating the threshold voltage bias to move the at least one electrophoretic particle from the first electrode to the second electrode.

In the display embodiments described herein, they may be used in applications such as in, but not limited to, electronic book readers, portable computers, tablet computers, wearables, cellular telephones, smart cards, signs, watches, shelf labels, flash drives and outdoor billboards or outdoor signs.

While the principles of the disclosure have been illustrated in relation to the exemplary embodiments shown herein, the principles of the disclosure are not limited thereto and include any modification, variation or permutation thereof.

What is claimed is:

1. A reflective image display, comprising:
a transparent front sheet;
a plurality of frontward row electrodes;
a plurality of rearward column electrodes, the plurality of rearward column electrodes positioned apart from the plurality of frontward row electrodes;
a trapping electrode interposed between the plurality of frontward row electrodes and the plurality of rearward column electrodes, the trapping electrode comprising a plurality of apertures such that at least one aperture intersects a span between one of the plurality of the frontward row electrodes and one of the plurality of the rearward column electrodes; and
a voltage source to bias at least one of the plurality of frontward row electrodes, the rearward column electrodes and the trapping electrode.

2. The image display of claim 1, wherein the plurality of frontward row electrodes and the plurality of rearward column electrodes are positioned to form a cavity therebetween.

3. The image display of claim 1, wherein the trapping electrode comprises a continuous mesh.

4. The image display of claim 1, further comprising at least one electrophoretic particle.

5. The image display of claim 4, wherein the voltage bias source is configured to bias the trapping electrode relative to the frontward row electrodes and the rearward column electrodes to affect movement of the at least one electrophoretic particle.

6. The image display of claim 1, wherein a first of the frontward row electrodes and a first of the rearward column electrodes are positioned relative to a first of the plurality of apertures to form a pixel controllable by the voltage bias source.

7. The image display of claim 4, further comprising a dielectric layer.

8. The image display of claim 7, wherein the dielectric layer comprises a polymer or an inorganic material.

9. The image display of claim 4, further comprising a color filter array layer.

10. The image display of claim 4, further comprising a front light.

11. The image display of claim 4, further comprising a light diffusive layer.

12. An addressable pixel in a multi-pixel device, comprising:
a first electrode positioned substantially across from a rear electrode, the first electrode and the second electrode forming an electrode pair;
a voltage bias source coupled to the first electrode and the second electrode, the voltage bias source forming an electromagnetic field between the first electrode and the second electrode;
at least one charged electrophoretic particle and a medium disposed in between the first electrode and the second electrode; and
a trapping electrode positioned in the medium and interposed between the first electrode and the second electrode, the trapping electrode biased with a first voltage to modulate movement of the at least one electrophoretic particle from the first electrode to the second electrode.

13. The addressable pixel of claim 12, wherein the medium defines a fluidic medium.

14. The addressable pixel of claim 12, wherein the trapping electrode further comprises a continuous conductive mesh.

15. The addressable pixel of claim 12, wherein the trapping electrode further comprises at least one aperture to allow passage of the at least one electrophoretic particle therethrough.

16. The addressable pixel of claim 12, wherein the voltage bias source is configured to supply a substantially uniform voltage bias to the first and the second electrode.

17. The addressable pixel of claim 12, wherein the voltage bias source is configured to supply a modulating voltage bias to the trapping electrode.

18. The addressable pixel of claim 17, wherein the modulating voltage is configured to impede movement of the at least one electrophoretic particle from the first electrode to the second electrode.

19. A method for addressing a pixel in a multi-pixel display, the method comprising:
positioning at least one charged electrophoretic particle in a transparent medium disposed between a pair of opposing electrodes of an electrode pair;
biasing each electrode of the electrode pair with an initial voltage bias to form an electromagnetic field therebetween to attract the charged electrophoretic particle to one of a first electrode or the second electrode of the electrode pair; and
providing a threshold voltage bias at a location between the pair of opposing electrodes, the threshold voltage disrupting the electromagnetic field to thereby prevent movement of the at least one charged electrophoretic particle from the first electrode of the electrode pair to the second electrode of the electrode pair.

20. The method of claim 19, wherein the step of biasing each electrode further comprises biasing each of the first electrode and the second electrode to substantially the same voltage bias.

21. The method of claim 19, wherein the step of biasing each electrode further comprises biasing each of the first electrode and the second electrode to different voltage biases.

22. The method of claim 19, wherein the step of biasing each electrode further comprises forming a voltage gradient between the first electrode and the second electrode.

23. The method of claim 19, further comprising modulating the threshold voltage bias to control movement of the at least one electrophoretic particle between the first and second electrode.

24. The method of claim 23, further comprising addressing the pixel by modulating the threshold voltage bias to move the at least one electrophoretic particle from the first electrode to the second electrode.

25. A tangible machine-readable non-transitory storage medium that contains instructions, which when executed by one or more processors results in performing operations comprising:
positioning at least one charged electrophoretic particle in a transparent medium disposed between a pair of opposing electrodes of an electrode pair;
biasing each electrode of the electrode pair with an initial voltage bias to form an electromagnetic field therebetween to attract the at least one charged electrophoretic particle to one of a first electrode or the second electrode of the electrode pair; and
providing a threshold voltage bias at a location between the pair of opposing electrodes, the threshold voltage interrupting the electromagnetic field to thereby prevent movement of the at least one charged electrophoretic particle from the first electrode of the electrode pair to the second electrode of the electrode pair.

26. The tangible machine-readable non-transitory storage medium of claim 25, wherein the step of biasing each electrode further comprises biasing each of the first electrode and the second electrode to substantially the same bias.

27. The tangible machine-readable non-transitory storage medium of claim 25, wherein the step of biasing each electrode further comprises biasing each of the first electrode and the second electrode to different biases.

28. The tangible machine-readable non-transitory storage medium of claim 25, wherein the step of biasing each electrode further comprises forming a voltage gradient between the first electrode and the second electrode.

29. The tangible machine-readable non-transitory storage medium of claim 25, further comprising modulating the threshold voltage bias to control movement of the at least one electrophoretic particle between the first and second electrode.

30. The tangible machine-readable non-transitory storage medium of claim 29, further comprising addressing the pixel by modulating the threshold voltage bias to move the at least one electrophoretic particle from the first electrode to the second electrode.
